(19) United States
(12) Patent Application Publication
(10) Pub. No.: US 2026/0139789 A1
(43) Pub. Date: May 21, 2026

(54) INTERLOCKING SUPPORT LEG STRUCTURE AND TRIPOD

(71) Applicant: SHENZHEN LEQI INNOVATION CO., LTD., Shenzhen City (CN)

(72) Inventor: SHAORUI TANG, Shenzhen City (CN)

(73) Assignee: SHENZHEN LEQI INNOVATION CO., LTD., Shenzhen City (CN)

(21) Appl. No.: 19/446,915

(22) Filed: Jan. 12, 2026

Related U.S. Application Data
(63) Continuation of application No. PCT/CN2023/135114, filed on Nov. 29, 2023.

(30) Foreign Application Priority Data
Jul. 13, 2023 (CN) 202321855057.0

(51) Int. Cl. F16M 11/32

(52) U.S. Cl. CPC F16M 11/32

(57) ABSTRACT

An interlocking support leg structure includes outer tube members, a middle tube member, an inner tube member, an upper locking assembly, a driving tube member, and a lower locking assembly. The outer tube members and the inner tube members are extendable relative to the middle tube member. The outer tube members are locked to the middle tube member by means of the upper locking assembly, the inner tube member is locked to the middle tube member by means of the lower locking assembly, and the upper locking assembly and the lower locking assembly are synchronously driven by means of the driving tube member, thereby achieving synchronous unlocking or locking of the interlocking support leg structure. The structure is simple, space-saving and convenient to operate.

### CROSS-REFERENCE TO RELATED APPLICATIONS

The present invention is a continuation of International Patent Application No. PCT/CN2023/135114 filed on November 29, 2023, which claims the priority of China patent Application No. 202321855057.0 filed on July 13, 2023, the entire contents of which are incorporated herein by reference.

### TECHNICAL FIELD

The present invention relates to the field of photographic equipment technology, and particularly relates to an interlocking support leg structure and a tripod.

### BACKGROUND

A tripod is a conventionally known, commonly used support structure that utilizes three support legs to provide a stable and reliable support platform for other equipment. Although tripods are most commonly used as a support for devices such as cameras, they also have many other potential uses. For example, tripods can also be used to support laser sights for surveying, camcorders for videography, telescopes for sky observation, or the like.

To assist in photography and achieve better results, the support legs of the tripods often feature a telescopic function, allowing adjustment of the camera's shooting height. However, the existing tripods often have complex leg adjustment structures and occupy considerable space, making them quite inconvenient to carry.

### SUMMARY

Accordingly, the present application is directed to an interlocking support leg structure that is simple in structure, space-saving, and convenient to carry.

In one aspect, an interlocking support leg structure is provided which includes: two outer tube members arranged in parallel, wherein an upper sliding bracket is slidably arranged on the outer tube members, and a lower connecting bracket is fixedly arranged at lower end portions of the outer tube members; a middle tube member slidably arranged between the two outer tube members, wherein an upper end portion of the middle tube member is fixed to the upper sliding bracket, and a lower end portion of the middle tube member slidably passes through the lower connecting bracket; an inner tube member, wherein an upper end portion of the inner tube member extends through the lower end portion of the middle tube member and is slidably arranged within the middle tube member; an upper locking assembly mounted on the upper sliding bracket to unlock or lock the upper sliding bracket, wherein in an unlocked state of the upper sliding bracket, the upper sliding bracket is slidable along the outer tube members, and in a locked state of the upper sliding bracket, the upper sliding bracket is locked onto the outer tube members; a driving tube member, wherein an upper end portion of the driving tube member is operatively connected to the upper locking assembly, and the driving tube member is arranged surrounding the middle tube member; and a lower locking assembly mounted on the lower end portion of the driving tube member and the lower end portion of the middle tube member, and arranged surrounding a periphery of the middle tube member. When the upper locking assembly unlocks the upper sliding bracket, the upper locking assembly drives the driving tube member to rotate in a first direction to actuate the lower locking assembly to unlock the inner tube member; and when the upper locking assembly locks the upper sliding bracket, the upper locking assembly drives the driving tube member to rotate in a second direction to actuate the lower locking assembly to lock the inner tube member.

In some embodiments, the upper locking assembly comprises an operating member and a rotating shaft member, wherein the operating member is engaged with the rotating shaft member, and the rotating shaft member is rotatably mounted on the upper sliding bracket; wherein when the operating member is operated to rotate about the rotating shaft member, the operating member drives the rotating shaft member to rotate, causing a lower end portion of the rotating shaft member to drive the driving tube member to rotate in the first direction or the second direction, while unlocking or locking the upper sliding bracket.

In some embodiments, the upper sliding bracket comprises a base cover and a bracket body, wherein the two outer tube members slidably extend through the bracket body and are disposed between the base cover and the bracket body; the rotating shaft member comprises a cam portion; the upper locking assembly further comprises a sleeve member, wherein one end of the sleeve member passes through the bracket body and is connected to the base cover, and another end of the sleeve member is attached around the cam portion; the cam portion is rotatably accommodated within the sleeve member, and both ends of the cam portion are rotatably connected to the bracket body. When the operating member rotates, the cam portion moves the sleeve member, causing the sleeve member to drive the base cover to clamp the two outer tube members, or the cam portion releases the sleeve member, causing the base cover to release the two outer tube members.

In some embodiments, the sleeve member comprises a rod portion and a sleeve portion, wherein one end of the rod portion is connected to the sleeve portion, and the other end is connected to the base cover; the cam portion extends through the sleeve portion; the upper locking assembly further comprises an elastic member attached on the rod portion and compressed between the sleeve portion and the bracket body.

In some embodiments, a connecting portion protrudes from a bottom end of the bracket body; the upper end portion of the middle tube member is fixedly connected to the connecting portion; a connecting sleeve is attached on an outer surface of the connecting portion, wherein an internal gear ring is formed on an inner wall surface of the connecting sleeve; a lower end portion of the rotating shaft member has a gear portion that extends into the connecting portion to mesh with the internal gear ring.

In some embodiments, the lower locking assembly comprises a driving sleeve, an elastic sleeve sleeved on the inner tube member, and a pressing member fixedly connected to the lower end portion of the middle tube member; the lower end portion of the driving tube member is connected to the driving sleeve. When the driving tube member rotates to drive the driving sleeve to rotate, the driving tube member causes the elastic sleeve to move upward or downward, thereby causing the pressing member to press the elastic sleeve against the inner tube member or release the elastic sleeve.

In some embodiments, an outer diameter of the elastic sleeve gradually decreases from its lower end to its upper end; a clamping groove that matches the elastic sleeve is provided inside the pressing member; the driving sleeve has an internal thread engaged with an external thread of the pressing member; the driving sleeve is connected to a lower end of the elastic sleeve, and the elastic sleeve is located within the driving sleeve.

In some embodiments, an external thread of the driving sleeve is screwed with an internal thread of the lower end portion of the driving tube member; the external thread of the driving sleeve is further screwed with a limiting ring to lock the driving sleeve onto the driving tube member.

In some embodiments, two anti-slip plates are provided on opposite sides of the upper end portion of the inner tube member.

In another aspect, a tripod is provided which includes a mounting base, and the interlocking support leg structure as described above. The outer tube members of the interlocking support leg structure are rotatably connected to the mounting base.

In view of the foregoing, in embodiments of the interlocking support leg structure, when the upper locking assembly unlocks the upper sliding bracket, the driving tube member is driven by a user to rotate in a first direction, causing the lower locking assembly to unlock the inner tube member. After the upper sliding bracket is unlocked, it can slide along the two outer tube members to achieve extension or retraction of the two outer tube members relative to the middle tube member. After the lower locking assembly unlocks the inner tube member, the inner tube member is allowed to slide within the middle tube member to achieve extension or retraction of the inner tube member relative to the middle tube member. After the middle tube member, the inner tube member, and the outer tube members are adjusted to appropriate positions, when the upper locking assembly locks the upper sliding bracket, the driving tube member is driven to rotate in a second direction, causing the lower locking assembly to lock the inner tube member. Consequently, the inner tube member cannot move relative to the middle tube member. After the upper sliding bracket is locked, it is secured to the outer tube members, and the middle tube member cannot slide relative to the outer tube members. Synchronous unlocking or locking of the interlocking support leg structure via the driving tube member is thus achieved. When the interlocking support leg structure is in a retracted state, the middle tube member is located between the two outer tube members, and the inner tube member slides into the middle tube member. In use, the user rotates the driving tube member to synchronously unlock the upper locking assembly and the lower locking assembly, allowing for adjusting the overall height of the interlocking support leg structure. The interlocking support leg structure is simple, space-saving, easy to operate, and convenient to carry.

### BRIEF DESCRIPTION OF THE DRAWINGS

FIG. 1 is a partially exploded view of an interlocking support leg structure according to one embodiment.

FIG. 2 is another exploded view of the interlocking support leg structure according to one embodiment.

FIG. 3 is an enlarged view of a portion of the interlocking support leg structure of FIG. 2.

FIG. 4 is a partial cross-sectional view of the interlocking support leg structure according to one embodiment.

FIG. 5 is another partial cross-sectional view of the interlocking support leg structure according to one embodiment.

### Reference Numerals:

Outer tube member 1

Middle tube member 2

Inner tube member 3; Anti-slip plate 31

Driving tube member 4

Upper sliding bracket 5; Bottom cover 51; Bracket body 52; Connecting portion 53; Connecting sleeve 54

Lower connecting bracket 6

Upper locking assembly 7; Operating member 71; Rotating shaft member 72; Gear portion 721; Sleeve member 73; Sleeve portion 731; Rod portion 732; Elastic member 74

Lower locking assembly 8; Driving sleeve 81; Elastic sleeve 82; Pressing member 83; Clamping groove 831; Limiting ring 84

### DESCRIPTION OF THE EMBODIMENTS

The following describes solutions in the embodiments of the present application clearly and completely with reference to the accompanying drawings. Obviously, the described embodiments are only a part, not all, of the embodiments of the present application. All other embodiments obtained by a person of ordinary skill in the art based on the described embodiments without making creative efforts shall fall within the protection scope of the present application. It should be noted that the descriptions relating to "first", "second", etc., in this disclosure are for descriptive purposes only and are not to be construed as indicating or implying relative importance or implicitly specifying the quantity of the indicated technical features.

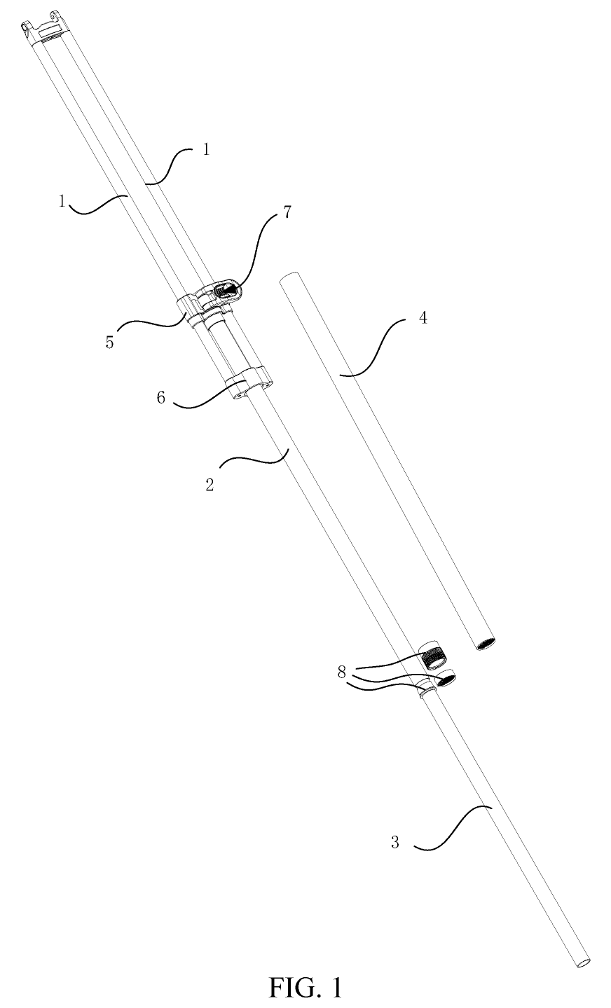

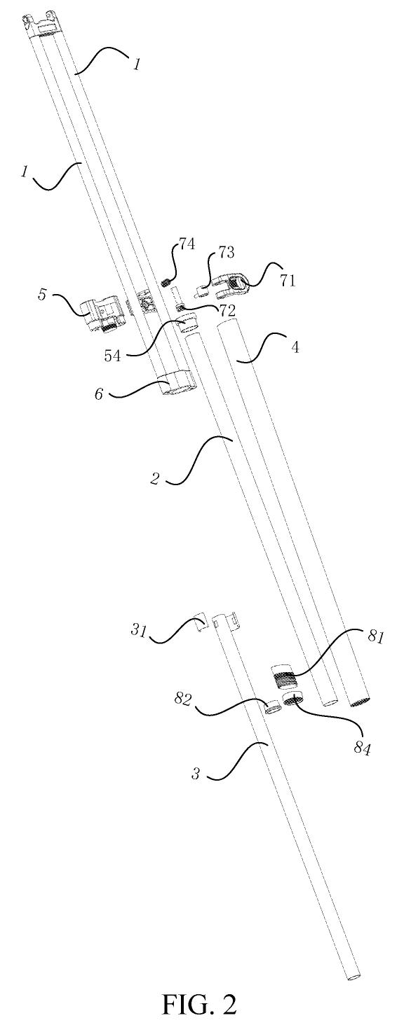

In order to address the technical deficiencies existing in the related art, as shown in FIG. 1 and FIG. 2, an interlocking support leg structure in accordance with an embodiment of the present application includes two outer tube members 1 arranged in parallel, a middle tube member 2, an inner tube member 3, an upper locking assembly 7, a driving tube member 4, and a lower locking assembly 8.

An upper sliding bracket 5 is slidably arranged on the outer tube members 1, a lower connecting bracket 6 is fixedly arranged at lower end portions of the outer tube members 1, such that the upper sliding bracket 5 is slidable along the two outer tube members 1, and the lower connecting bracket 6 fixedly connects the lower end portions of the two outer tube members 1 to each other.

The middle tube member 2 is slidably arranged between the two outer tube members 1. An upper end portion of the middle tube member 2 is fixed to the upper sliding bracket 5, and a lower end portion of the middle tube member 2 slidably passes through the lower connecting bracket 6.

The inner tube member 3 has an upper end portion inserted into the lower end portion of the middle tube member 2 and is slidably arranged within the middle tube member 2.

The upper locking assembly 7 is mounted on the upper sliding bracket 5 to selectively unlock or lock the upper sliding bracket 5. When unlocked, the upper sliding bracket 5 can slide along the outer tube members 1. When locked, the upper sliding bracket 5 is locked onto and thus cannot slide relative to the outer tube members 1.

The driving tube member 4 has an upper end portion operatively connected to the upper locking assembly 7. The driving tube member 4 is arranged surrounding a periphery of the middle tube member 2.

The lower locking assembly 8 is mounted on a lower end portion of the driving tube member 4 and the lower end portion of the middle tube member 2, and is sleeved on the inner tube member 3.

When the upper locking assembly 7 unlocks the upper sliding bracket 5, the driving tube member 4 is driven by a user to rotate in a first direction, causing the lower locking assembly 8 to unlock the inner tube member 3. After the upper sliding bracket 5 is unlocked, it can slide along the two outer tube members 1 to achieve extension or retraction of the two outer tube members 1 relative to the middle tube member 2. After the lower locking assembly 8 unlocks the inner tube member 3, the inner tube member 3 is allowed to slide within the middle tube member 2 to achieve extension or retraction of the inner tube member 3 relative to the middle tube member 2. After the middle tube member 2, the inner tube member 3, and the outer tube members 1 are adjusted to appropriate positions, when the upper locking assembly 7 locks the upper sliding bracket 5, the driving tube member 4 is driven to rotate in a second direction, causing the lower locking assembly 8 to lock the inner tube member 3. Consequently, the inner tube member 3 cannot move relative to the middle tube member 2. After the upper sliding bracket 5 is locked, it is secured to the outer tube members 1, and the middle tube member 2 cannot slide relative to the outer tube members 1. Synchronous unlocking or locking of the interlocking support leg structure via the driving tube member 4 is thus achieved. When the interlocking support leg structure is in a retracted state, the middle tube member 2 is located between the two outer tube members 1, and the inner tube member 3 slides into the middle tube member 2. In use, the user rotates the driving tube member 4 to synchronously unlock the upper locking assembly 7 and the lower locking assembly 8, allowing for adjusting the overall height of the interlocking support leg structure. The structure is simple, space-saving, easy to operate, and convenient to carry. The first direction and the second direction can be opposite directions, such as clockwise rotation and counterclockwise rotation, respectively.

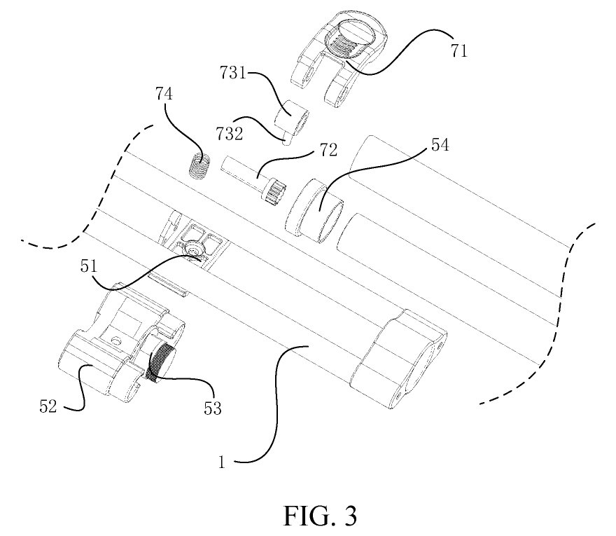

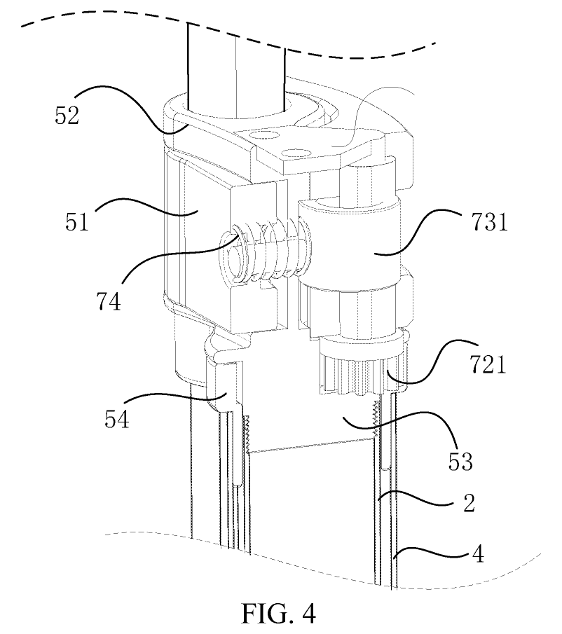

In some optional examples, as shown in FIG. 3 and FIG. 4, the upper locking assembly 7 includes an operating member 71 and a rotating shaft member 72. The operating member 71 is engaged with the rotating shaft member 72 so that when the operating member 71 rotates, it drives the rotating shaft member 72 to rotate together. The rotating shaft member 72 is rotatably mounted on the upper sliding bracket 5. When the operating member 71 is operated to rotate about the rotating shaft member 72, it drives the rotating shaft member 72 to rotate, causing a lower end portion of the rotating shaft member 72 to drive the driving tube member 4 to rotate in the first direction or the second direction.

In this embodiment, the rotating shaft member 72 may extend through the operating member 71. A portion of the rotating shaft member 72 extending through the operating member 71 may have an asymmetrical circular shape, and the operating member 71 has a through hole with a shape matching that portion of the rotating shaft member 72. When the operating member 71 is operated to rotate about the rotating shaft member 72 in one direction, it drives the rotating shaft member 72 to rotate, causing the lower end portion of the rotating shaft member 72 to drive the driving tube member 4 to rotate in the first direction, thereby actuating the lower locking assembly 8 to unlock the inner tube member 3, and synchronously actuating the upper locking assembly 7 to unlock the upper sliding bracket 5. When the operating member 71 is operated to rotate about the rotating shaft member 72 in another direction, it drives the rotating shaft member 72 to rotate, causing the lower end portion of the rotating shaft member 72 to drive the driving tube member 4 to rotate in the second direction, thereby actuating the lower locking assembly 8 to lock the inner tube member 3, and simultaneously actuating the upper locking assembly 7 to lock the upper sliding bracket 5. The structure is simple and has a compact size.

With continuing reference to FIG. 3 and FIG. 4, the upper sliding bracket 5 includes a base cover 51 and a bracket body 52. The two outer tube members 1 slidably extend through the bracket body 52 and are disposed between the base cover 51 and the bracket body 52. The rotating shaft member 72 includes a cam portion. The upper locking assembly 7 further includes a sleeve member 73. One end of the sleeve member 73 passes through the bracket body 52 to connect to the base cover 51, and another end of the sleeve member 73 is sleeved around the cam portion. The cam portion is rotatably accommodated within the sleeve member 73, and both ends of the cam portion are rotatably connected to the bracket body 52.

When the operating member 71 rotates, the cam portion moves the sleeve member 73, causing the sleeve member 73 to drive the base cover 51 to clamp the two outer tube members 1, or the cam portion releases the sleeve member 73, causing the base cover 51 to release the two outer tube members 1. In the locked state, a top of the cam portion abuts against an inner top wall of the sleeve member 73. In the unlocked state, the cam portion releases its abutment against the inner top wall of the sleeve member 73.

In this embodiment, the bracket body 52 has sliding holes extending therethrough for slidably accommodating the outer tube members 1. The sliding holes may have openings so that when squeezed by the base cover 51, inner walls defining the sliding holes deform to clamp the outer tube members 1. The one end of the sleeve member 73 may be threadedly connected to the base cover 51. When the cam portion rotates, it can pull the sleeve member 73 upward, such that the sleeve member 73 can drive the base cover 51 to press against the bracket body 52, thereby clamping the two outer tube members 1. After the peak of the cam portion rotates away, the cam portion releases the sleeve member 73, and the sleeve member 73 releases the base cover 51, allowing the outer tube members 1 to slide within the bracket body 52.

With continuing reference to FIG. 3 and FIG. 4, the sleeve member 73 in this embodiment includes a rod portion 732 and a sleeve portion 731. One end of the rod portion 732 is connected to the sleeve portion 731, and the other end is connected to the base cover 51. The cam portion passes through the sleeve portion 731. The upper locking assembly 7 further includes an elastic member 74. The elastic member 74 is attached round the rod portion 732 and compressed between the sleeve portion 731 and the bracket body 52. In this embodiment, the sleeve portion 731 has a through hole, and the cam portion is rotatably accommodated within the sleeve portion 731. The elastic member 74 facilitates the operating member 71 releasing the base cover 51, applying a force to the base cover 51 away from the bracket body 52. The elastic member 74 can be a spring.

In some optional examples, referring to FIG. 3 and FIG. 4, a connecting portion 53 protrudes from a bottom end of the bracket body 52. The upper end portion of the middle tube member 2 is fixedly connected to the connecting portion 53. A connecting sleeve 54 is attached on an outer surface of the connecting portion 53. An internal gear ring is formed on an inner wall surface of the connecting sleeve 54. A lower end portion of the rotating shaft member 72 includes a gear portion 721, which extends into the connecting portion 53 to mesh with the internal gear ring.

In a specific embodiment, the upper end portion of the middle tube member 2 may be threadedly connected to the connecting portion 53 for easy assembly and disassembly. The connecting sleeve 54 is rotatably attached on the outer surface of the connecting portion 53, for example, via a convex-concave structure. The internal gear ring has a plurality of internal teeth, and the gear portion 721 has a plurality of external teeth. When the rotating shaft member 72 rotates, the external teeth mesh with the internal teeth to drive the driving tube member 4 to rotate. The gear portion 721 passes through the bracket body 52 into the connecting portion 53. The connecting portion 53 is provided with a recess, and the gear portion 721 is rotatably accommodated within this recess. The internal teeth are oriented toward the opening of the recess.

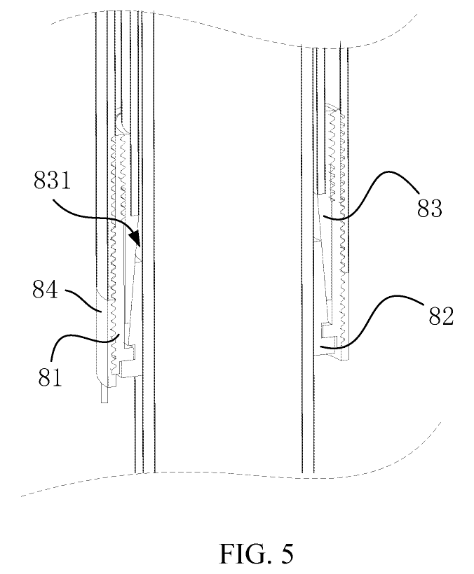

In some optional examples, referring to FIG. 2 and FIG. 5, the lower locking assembly 8 includes a driving sleeve 81, an elastic sleeve 82 on the inner tube member 3, and a pressing member 83 fixedly connected to the lower end portion of the middle tube member 2. The lower end portion of the driving tube member 4 is connected to the driving sleeve 81. When the driving tube member 4 rotates to drive the driving sleeve 81 to rotate, it causes the elastic sleeve 82 to move upward or downward, thereby making the pressing member 83 press the elastic sleeve 82 against the inner tube member 3 or release the elastic sleeve 82.

In a specific embodiment, the elastic sleeve 82 includes a sleeve body that is hollow at a center thereof. The sleeve body may have several slits extending to its upper end portion and/or lower end portion to allow elastic deformation for clamping or releasing the inner tube member 3. The elastic sleeve 82 can be made of plastic. When the driving tube member 4 rotates in the first direction to drive the driving sleeve 81 to rotate, the driving sleeve 81 drives the elastic sleeve 82 to move downward relative to the pressing member 83, so that the elastic sleeve 82 is released, and thus the elastic sleeve 82 releases the inner tube member 3. When the driving tube member 4 rotates in the opposite second direction to drive the driving sleeve 81 to rotate, the driving sleeve 81 drives the elastic sleeve 82 to move upward into the pressing member 83, so that the elastic sleeve 82 is compressed, and thus the elastic sleeve 82 clamps the inner tube member 3. In this state, the pressing member 83 is clamped between the elastic sleeve 82 and the driving sleeve 81.

Specifically, the elastic sleeve 82 has an outer diameter that gradually decreases from its lower end to its upper end. A clamping groove 831 that matches the elastic sleeve 82 is provided inside the pressing member 83. The driving sleeve 81 has an internal thread engaged with an external thread on the pressing member 83. The lower end of the driving sleeve 81 is connected to the lower end of the elastic sleeve 82, and the elastic sleeve 82 is located within the driving sleeve 81. The clamping groove 831 has a tapered inner wall that matches the shape of the elastic sleeve 82. The elastic sleeve 82 can be made of plastic or alloy.

In some optional examples, with continuing reference to FIG. 2 and FIG. 5, to adjust the length of the driving tube member 4, an external thread of the driving sleeve 81 is engaged with an internal thread on the lower end portion of the driving tube member 4. A limiting ring 84 is also screwed onto the external thread of the driving sleeve 81 to lock the driving sleeve 81 onto the driving tube member 4. After adjusting the insertion depth of the driving sleeve 81 screwed into the driving tube member 4, the limiting ring 84 is screwed onto the external thread of the driving sleeve 81 until it abuts against the lower end portion of the driving tube member 4, thereby locking the driving tube member 4 onto the driving sleeve 81. When the driving tube member 4 rotates, it drives the driving sleeve 81 to rotate together, without producing relative movement between the driving tube member 4 and the driving sleeve 81.

With continuing reference to FIG. 2 and FIG. 5, two anti-slip plates 31 are further provided on opposite sides of the upper end portion of the inner tube member 3. The anti-slip plates 31 provide damping for the sliding movement between the inner tube member 3 and the middle tube member 2, ensuring smooth operation. The anti-slip plates 31 may engage with the inner tube member 3 via a convex-concave structure.

In summary, during the unlocking process of the interlocking support leg structure, when the operating member 71 is rotated in one direction about the rotating shaft member 72, it drives the cam portion of the rotating shaft member 72 to rotate. This causes the cam portion to release the inner top wall of the sleeve portion 731. Simultaneously, the elastic member 74 pushes the base cover 51 away from the bracket body 52 to unlock the two outer tube members 1, and the gear portion 721 of the rotating shaft member 72 drives the internal gear ring of the connecting sleeve 54, which causes the driving tube member 4 to rotate in the first direction, actuating the lower locking assembly 8 to unlock the inner tube member 3. During the unlocking of the inner tube member 3 by the lower locking assembly 8, when the driving tube member 4 rotates in the first direction, it drives the driving sleeve 81 to move axially downward along the pressing member 83. This causes the elastic sleeve 82 to move downward out of the clamping groove 831, so that the clamping force applied by the pressing member 83 to the elastic sleeve 82 gradually decreases or disappears. As a result, the elastic sleeve 82 deforms to release the inner tube member 3, thereby unlocking the inner tube member. At this time, the height of the interlocking support leg structure can be adjusted by adjusting the extension/retraction of the outer tube members 1, middle tube member 2, and inner tube member 3. After adjustment of the height of the interlocking support leg structure, the driving tube member 4 is rotated again to lock the interlocking support leg structure.

During the locking process of the interlocking support leg structure, when the operating member 71 is rotated in the other direction about the rotating shaft member 72, it drives the cam portion of the rotating shaft member 72 to rotate. This causes the cam portion to pull the inner top wall of the sleeve portion 731 upward. Simultaneously, the elastic member 74 is compressed between the bracket body 52 and the sleeve portion 731, and the rod portion 732 pulls the base cover 51 towards the bracket body 52 to lock the two outer tube members 1. Concurrently, the gear portion 721 of the rotating shaft member 72 drives the internal gear ring to rotate, which causes the driving tube member 4 to rotate in the second direction, actuating the lower locking assembly 8 to lock the inner tube member 3. During the locking of the inner tube member 3 by the lower locking assembly 8, when the driving tube member 4 rotates in the second direction, it drives the driving sleeve 81 to move axially upward along the pressing member 83. This causes the elastic sleeve 82 to move upward into the clamping groove 831, so that the clamping force applied by the pressing member 83 to the elastic sleeve 82 gradually increases. As a result, the elastic sleeve 82 deforms to clamp the inner tube member 3, thereby locking the inner tube member. The adjustment is then completed.

The present application also provides a tripod that includes a mounting base and three interlocking support leg structures. Outer tube members of the interlocking support leg structures are rotatably connected to the mounting base, allowing the tripod to have a small volume when in a stored state. At least one of the interlocking support leg structures of the tripod may be constructed as described in the above embodiments. As this tripod adopts all the technical solutions of the above embodiments, it possesses all the technical effects brought by them, which will not be repeated herein.

The above descriptions are only partial or preferred embodiments of the present application. Neither the text nor the drawings may therefore limit the scope of protection of the present application. Any equivalent structural transformations made under the overall concept of the present application based on the description and drawings of the present application, or direct/indirect application in other related technical fields, shall be included within the protection scope of the present application.

What is claimed is:

1. An interlocking support leg structure, comprising:
two outer tube members arranged in parallel, wherein an upper sliding bracket is slidably arranged on the outer tube members, and a lower connecting bracket is fixedly arranged at lower end portions of the outer tube members;
a middle tube member slidably arranged between the two outer tube members, wherein an upper end portion of the middle tube member is fixed to the upper sliding bracket, and a lower end portion of the middle tube member slidably passes through the lower connecting bracket;
an inner tube member, wherein an upper end portion of the inner tube member extends through the lower end portion of the middle tube member and is slidably arranged within the middle tube member;
an upper locking assembly mounted on the upper sliding bracket to unlock or lock the upper sliding bracket, wherein in an unlocked state of the upper sliding bracket, the upper sliding bracket is slidable along the outer tube members, and in a locked state of the upper sliding bracket, the upper sliding bracket is locked onto the outer tube members;
a driving tube member, wherein an upper end portion of the driving tube member is operatively connected to the upper locking assembly, and the driving tube member is arranged surrounding the middle tube member; and
a lower locking assembly mounted on the lower end portion of the driving tube member and the lower end portion of the middle tube member, and arranged surrounding a periphery of the middle tube member;
wherein, when the upper locking assembly unlocks the upper sliding bracket, the upper locking assembly drives the driving tube member to rotate in a first direction to actuate the lower locking assembly to unlock the inner tube member; and when the upper locking assembly locks the upper sliding bracket, the upper locking assembly drives the driving tube member to rotate in a second direction to actuate the lower locking assembly to lock the inner tube member.

2. The interlocking support leg structure according to claim 1, wherein the upper locking assembly comprises an operating member and a rotating shaft member, wherein the operating member is engaged with the rotating shaft member, and the rotating shaft member is rotatably mounted on the upper sliding bracket;
wherein when the operating member is operated to rotate about the rotating shaft member, the operating member drives the rotating shaft member to rotate, causing a lower end portion of the rotating shaft member to drive the driving tube member to rotate in the first direction or the second direction, while unlocking or locking the upper sliding bracket.

3. The interlocking support leg structure according to claim 2 wherein:
the upper sliding bracket comprises a base cover and a bracket body, wherein the two outer tube members slidably extend through the bracket body and are disposed between the base cover and the bracket body;
the rotating shaft member comprises a cam portion;
the upper locking assembly further comprises a sleeve member, wherein one end of the sleeve member passes through the bracket body and is connected to the base cover, and another end of the sleeve member is attached around the cam portion;
the cam portion is rotatably accommodated within the sleeve member, and both ends of the cam portion are rotatably connected to the bracket body;
wherein when the operating member rotates, the cam portion moves the sleeve member, causing the sleeve member to drive the base cover to clamp the two outer tube members, or the cam portion releases the sleeve member, causing the base cover to release the two outer tube members.

4. The interlocking support leg structure according to claim 3 wherein:
the sleeve member comprises a rod portion and a sleeve portion, wherein one end of the rod portion is connected to the sleeve portion, and the other end is connected to the base cover;
the cam portion extends through the sleeve portion;
the upper locking assembly further comprises an elastic member attached on the rod portion and compressed between the sleeve portion and the bracket body.

5. The interlocking support leg structure according to claim 3 wherein:
a connecting portion protrudes from a bottom end of the bracket body;
the upper end portion of the middle tube member is fixedly connected to the connecting portion;
a connecting sleeve is attached on an outer surface of the connecting portion, wherein an internal gear ring is formed on an inner wall surface of the connecting sleeve;
a lower end portion of the rotating shaft member has a gear portion that extends into the connecting portion to mesh with the internal gear ring.

6. The interlocking support leg structure according to claim 1 wherein:
the lower locking assembly comprises a driving sleeve, an elastic sleeve sleeved on the inner tube member, and a pressing member fixedly connected to the lower end portion of the middle tube member;
the lower end portion of the driving tube member is connected to the driving sleeve;
wherein when the driving tube member rotates to drive the driving sleeve to rotate, the driving tube member causes the elastic sleeve to move upward or downward, thereby causing the pressing member to press the elastic sleeve against the inner tube member or release the elastic sleeve.

7. The interlocking support leg structure according to claim 6 wherein:
an outer diameter of the elastic sleeve gradually decreases from its lower end to its upper end;
a clamping groove that matches the elastic sleeve is provided inside the pressing member;
the driving sleeve has an internal thread engaged with an external thread of the pressing member;
the driving sleeve is connected to a lower end of the elastic sleeve, and the elastic sleeve is located within the driving sleeve.

8. The interlocking support leg structure according to claim 6 wherein:
an external thread of the driving sleeve is screwed with an internal thread of the lower end portion of the driving tube member;
the external thread of the driving sleeve is further screwed with a limiting ring to lock the driving sleeve onto the driving tube member.

9. The interlocking support leg structure according to claim 1 wherein:
an anti-slip plate is provided on the upper end portion of the inner tube member.

10. A tripod comprising:
a mounting base; and
an interlocking support leg structure according to claim 1 wherein the outer tube members of the interlocking support leg structure are rotatably connected to the mounting base.

11. The tripod according to claim 10 wherein the upper locking assembly comprises an operating member and a rotating shaft member, wherein the operating member is engaged with the rotating shaft member, and the rotating shaft member is rotatably mounted on the upper sliding bracket;
wherein when the operating member is operated to rotate about the rotating shaft member, the operating member drives the rotating shaft member to rotate, causing a lower end portion of the rotating shaft member to drive the driving tube member to rotate in the first direction or the second direction, while unlocking or locking the upper sliding bracket.

12. The tripod according to claim 11 wherein:
the upper sliding bracket comprises a base cover and a bracket body, wherein the two outer tube members slidably extend through the bracket body and are disposed between the base cover and the bracket body;
the rotating shaft member comprises a cam portion;
the upper locking assembly further comprises a sleeve member, wherein one end of the sleeve member passes through the bracket body and is connected to the base cover, and another end of the sleeve member is attached around the cam portion;
the cam portion is rotatably accommodated within the sleeve member, and both ends of the cam portion are rotatably connected to the bracket body;
wherein when the operating member rotates, the cam portion moves the sleeve member, causing the sleeve member to drive the base cover to clamp the two outer tube members, or the cam portion releases the sleeve member, causing the base cover to release the two outer tube members.

13. The tripod according to claim 12 wherein:
the sleeve member comprises a rod portion and a sleeve portion, wherein one end of the rod portion is connected to the sleeve portion, and the other end is connected to the base cover;
the cam portion extends through the sleeve portion;
the upper locking assembly further comprises an elastic member attached on the rod portion and compressed between the sleeve portion and the bracket body.

14. The tripod according to claim 12 wherein:
a connecting portion protrudes from a bottom end of the bracket body;
the upper end portion of the middle tube member is fixedly connected to the connecting portion;
a connecting sleeve is attached on an outer surface of the connecting portion, wherein an internal gear ring is formed on an inner wall surface of the connecting sleeve;
a lower end portion of the rotating shaft member has a gear portion that extends into the connecting portion to mesh with the internal gear ring.

15. The tripod according to claim 10 wherein:
the lower locking assembly comprises a driving sleeve, an elastic sleeve sleeved on the inner tube member, and a pressing member fixedly connected to the lower end portion of the middle tube member;
the lower end portion of the driving tube member is connected to the driving sleeve;
wherein when the driving tube member rotates to drive the driving sleeve to rotate, the driving tube member causes the elastic sleeve to move upward or downward, thereby causing the pressing member to press the elastic sleeve against the inner tube member or release the elastic sleeve.

16. The tripod according to claim 15 wherein:
an outer diameter of the elastic sleeve gradually decreases from its lower end to its upper end;
a clamping groove that matches the elastic sleeve is provided inside the pressing member;
the driving sleeve has an internal thread engaged with an external thread of the pressing member;
the driving sleeve is connected to a lower end of the elastic sleeve, and the elastic sleeve is located within the driving sleeve.

17. The tripod according to claim 15 wherein:
an external thread of the driving sleeve is screwed with an internal thread of the lower end portion of the driving tube member;
the external thread of the driving sleeve is further screwed with a limiting ring to lock the driving sleeve onto the driving tube member.

18. The tripod according to claim 10 wherein:
an anti-slip plate is provided on the upper end portion of the inner tube member.
